(19) United States
(12) Patent Application Publication
(10) Pub. No.: US 2025/0236285 A1
(43) Pub. Date: Jul. 24, 2025

(54) APPARATUS AND METHOD FOR CONTROLLING VEHICLE MOVEMENT

(71) Applicant: Jaguar Land Rover Limited, Whitley (GB)

(72) Inventors: Daniel WOOLLISCROFT, Birmingham (GB); Edward PITHER, Wolvey (GB); Helio CARDOSO, Coventry (GB); David PETTINGER, Coventry (GB)

(21) Appl. No.: 19/173,769

(22) Filed: Apr. 8, 2025

Related U.S. Application Data
(63) Continuation of application No. 18/404,811, filed on Jan. 4, 2024.
Application No. 18/404,811 is a continuation of application No. 17/829,305, filed on May 31, 2022, now Pat. No. 11,897,456.
Application No. 17/829,305 is a continuation of application No. 15/733,877, filed on Nov. 30, 2020, now Pat. No. 11,345,336.

(30) Foreign Application Priority Data
May 31, 2018 (GB) 1808895.5
May 31, 2018 (GB) 1808896.3
May 31, 2018 (GB) 1808898.9
May 31, 2018 (GB) 1808900.3
May 31, 2018 (GB) 1808902.9
May 31, 2018 (GB) 1808906.0
May 31, 2018 (GB) 1808908.6
May 31, 2018 (GB) 1808911.0
May 31, 2018 (GB) 1808917.7
May 31, 2018 (GB) 1808919.3
May 31, 2018 (GB) 1808920.1
Nov. 2, 2018 (GB) 1817940.8

(51) Int. Cl. B60W 30/06; B60W 60/00; G06F 9/38; G06V 20/56; G08G 1/14

(52) U.S. Cl. CPC B60W 30/06; B60W 60/001; G06F 9/3838; G06V 20/56; G08G 1/148

(57) ABSTRACT

Embodiments of the present invention provide a controller, comprising input means for receiving an environment signal indicative of a feature in a vicinity of a vehicle, output means for outputting a manoeuvre signal to cause a vehicle to perform a defined manoeuvre, and control means arranged to provide at least one mode for performing at least a portion of the defined manoeuvre, the mode being selectable from a plurality of modes including at least one mode corresponding to an occupant-in-vehicle mode and at least one mode corresponding to an occupant-out-of-vehicle mode, the mode being selectable in dependence upon the environment signal being indicative of a vehicle envelope suitable for the mode.

### TECHNICAL FIELD

The present disclosure relates to controlling movement of a vehicle and particularly, but not exclusively, to controlling performance of a defined manoeuvre by the vehicle. Aspects of the invention relate to a controller, to a system, to a method, to a vehicle and to computer software.

The present disclosure relates also to determining an orientation of a completed position of a vehicle, particularly, but not exclusively, to determining an orientation of a defined manoeuvre completed position of the vehicle. Aspects of the invention relate to a controller, to a system, to a method, to a vehicle and to computer software.

### BACKGROUND

It is known for a vehicle to perform a defined manoeuvre, such as an automatic, or semi-autonomous, parking manoeuvre. A user typically instructs the vehicle to identify a possible defined manoeuvre when the owner is ready, such as when the owner is looking for or at a parking location. The vehicle may be instructed to perform the manoeuvre remotely e.g. via a mobile device at which a user input is received to instruct the manoeuvre.

Environment sensing means of the vehicle are used to determine a location of features in a vicinity of the vehicle such as, although not exclusively, markings, walls, posts, other vehicles etc. The vehicle may then be instructed, such as via the mobile device or other input medium, to move to a parked location in relation to the features. For example, it may be desired for a vehicle to move into a parking space bounded by the features. In order to prevent the vehicle contacting an object the environment sensing means determines a distance between the vehicle and the object and the automatic parking manoeuvre is performed to leave the vehicle a separation distance from the object. For example, the vehicle may be reversed towards the feature, until an appropriate separation distance is determined by the environment sensing means. If a space is large enough to receive the vehicle, the vehicle is parked in the middle of the space-for example, to be positioned in the centre of a garage. Once the vehicle has reached a completed parked position, the vehicle is switched off, typically with a parking brake applied.

Sometimes the features bounding a parking space can inhibit access to or from the vehicle. For example, a wall adjacent a parking space can impede the opening of a vehicle door, impeding or preventing access via that door.

Driver preference can be to leave the vehicle steered wheels straightened when parked, such as to appear tidy or prevent a vehicle wheel from protruding laterally. In other situations, it is preferred or even required to cramp vehicle wheels on sloping terrain of any gradient.

The defined manoeuvre is typically performed in various ambient conditions, such as irrespective of weather or lighting.

Sometimes the features bounding a parking space can inhibit access to the space for a vehicle. For example, a parking space may be too narrow to allow the vehicle to manoeuvre into or out of the parking space, such as with sufficient clearance, or even be too narrow to receive the vehicle as such (e.g. narrower than a maximum width of the vehicle).

Defined manoeuvres can be performed on different terrains, such as differing ground surface type or smoothness.

Sometimes drivers like the vehicle to be neatly parked, desiring a precise parked position of the vehicle. Often drivers like the defined manoeuvre to be performed swiftly.

The vehicle may be instructed to perform the manoeuvre remotely e.g. via a mobile device at which a user input is received to instruct the manoeuvre. Alternatively the vehicle may be instructed to perform the manoeuvre with the user in the vehicle.

Performance of the manoeuvre generally moves the vehicle from a start position, such as outside the parking space, to a completed position, such as in the parking space. If the vehicle has reached a completed parked position, the user can switch the vehicle off, typically with a parking brake applied.

Once the vehicle has completed the defined manoeuvre the user can control the vehicle, such as to drive manually. If the vehicle has reached a completed parked position, the user can switch the vehicle off, typically with a parking brake applied.

It is an object of embodiments of the invention to at least mitigate one or more of the problems of the prior art.

### SUMMARY OF THE INVENTION

Aspects and embodiments of the invention provide a controller, a system, a method, a vehicle and computer software as claimed in the appended claims.

According to an aspect of the invention, there is provided a controller arranged to operably cause a vehicle to perform at least a portion of a defined manoeuvre in dependence on an ambient condition.

According to an aspect of the invention, there is provided a controller comprising: input means for receiving an ambient condition signal indicative of an ambient condition in a vicinity of a vehicle; output means for outputting a manoeuvre signal to cause the vehicle to perform a defined manoeuvre; and control means arranged to control the output means to cause the vehicle to perform at least a portion of the defined manoeuvre in dependence on the ambient condition signal. Advantageously, the vehicle may be caused to adapt the performance of the defined manoeuvre to suit the ambient condition.

The controller as described above, wherein:
the input means may comprise an electrical input for receiving the signal;
the output means may comprise an electrical output for outputting the signal; and
the control means may comprise one or more control devices such as electronic processing devices.

The defined manoeuvre may comprise a parking manoeuvre. The parking manoeuvre may comprise an in-parking manoeuvre, such as parking into a space to a stationary position. The parking manoeuvre may comprise an un-parking manoeuvre, such as parking out of a space from a stationary position. A defined manoeuvre completed position may comprise a parked position.

The control means may be arranged to control the output means to cause the vehicle to perform at least a portion of the defined manoeuvre in accordance with a vehicle movement control profile determined in dependence on the ambient condition signal. Advantageously, the vehicle may be caused to perform the defined manoeuvre in a controlled manner appropriate for the ambient condition.

The vehicle movement control profile may comprise a speed parameter. The speed parameter may be indicative of a first order speed parameter. Advantageously, the vehicle may be caused to perform the defined manoeuvre with a vehicle speed appropriate for the ambient condition.

The control means may be arranged to select the vehicle movement control profile in dependence on a categorisation of the ambient condition. Advantageously, the vehicle may select, such as automatically select, parameters for performance of the defined manoeuvre associated with predetermined categories of one or more ambient conditions.

The speed parameter may be indicative of an acceleration of the vehicle. Advantageously, the vehicle may be caused to perform the defined manoeuvre with an appropriate acceleration, such as to perform the defined manoeuvre efficiently and/or without undue acceleration of the vehicle or a user or content thereof.

The speed parameter may be indicative of a jerk of the vehicle. Advantageously, the vehicle may be caused to perform the defined manoeuvre with an appropriate rate of change of acceleration, which may be physically and/or psychologically appropriate for the user.

The speed parameter may comprise a maximum speed parameter. Advantageously, the vehicle may be caused to perform the defined manoeuvre with or within a maximum speed, acceleration and/or jerk; such that the defined manoeuvre is performed efficiently, and/or physically and/or psychologically appropriate for a user.

The maximum speed parameter of a vehicle movement control profile corresponding to a first ambient condition may be less than the maximum speed parameter of a vehicle movement control profile corresponding to a second ambient condition. Advantageously, the maximum speed parameter can be varied to suit a variation in the ambient condition.

The vehicle movement control profile may be dependent upon a terrain in a vicinity of the vehicle. Advantageously, the vehicle may be caused to adapt the performance of the defined manoeuvre to suit the terrain.

The control means may be arranged to select the vehicle movement control profile in dependence on a categorisation of the terrain. Advantageously, the vehicle may select, such as automatically select, parameters for performance of the defined manoeuvre associated with predetermined categories of terrain.

The terrain may be a surface. The surface may comprise a ground surface, such as a load-bearing surface (e.g. vehicle-bearing). The surface may comprise a driveable surface, such as for receiving at least one vehicle wheel thereon. The surface may comprise a substrate.

The terrain may comprise one or more of: a road terrain; an off-road terrain; a bumpy terrain; a smooth terrain; a slippy terrain; a flat terrain; a material. The terrain may be categorised in dependence on one or more parameters corresponding to one or more of: bumpiness; smoothness; roughness; grip; slip; friction; one or more gradients; one or more inclines; one or more materials. The one or more parameters may comprise a magnitude and/or a direction.

The ambient condition may comprise one or more of: a temperature; an air temperature; a surface temperature, such as a road temperature; precipitation, such as rain, snow, hail; moisture; humidity; fog; mist; particles, such as airborne particles; light level; wind; wind speed; wind direction. The categories for categorisation of the one or more ambient conditions may comprise categories corresponding to the types of the one or more ambient conditions. For example, the categories may comprise: hot; warm; cold; rainy; snowy; dry; wet; humid; foggy; misty; dark; light; windy etc. In at least some examples, multiple categories may be provided corresponding to each ambient condition parameter. For example, several categories may be provided for the temperature, such as “hot air”, “warm air”, “cold air”, “freezing air”; “hot road”, “warm road”, “cold road”, “freezing road”, etc. It will also be appreciated, that the one or more ambient conditions may be categorised in multiple categories simultaneously. For example, the one or more ambient conditions may be categorised as “warm, wet, windy and dark”. The one or more ambient conditions may comprise multiple such categories or parameters.

The controller may comprise a second input means for receiving a request signal indicative of a received signal indicative of a user request. The request signal may be indicative of a wired or a wirelessly received signal indicative of a user request, such as from a user's mobile device. Advantageously this may allow the vehicle to be effectively instructed from a user's mobile device, such as remotely instructed with the user out of the vehicle.

The user may comprise an occupant. The user may comprise a driver of the vehicle. The user may be located in the vehicle. The user may be located out of the vehicle, such as for at least a portion of performance of the defined manoeuvre. The vehicle may comprise one or more non-driver occupants. In at least some examples, one or more users and/or occupants may be located in and/or out of the vehicle.

The control means may be arranged to determine a vacancy. The control means may be arranged to define at least one vehicle envelope within the vacancy, the vehicle envelope being suitable for receiving the vehicle in the defined manoeuvre completed position. The control means may be arranged to define within the vacancy at least one defined manoeuvre completed position for the vehicle.

The vehicle envelope may comprise a target position suitable for receiving the vehicle in the defined manoeuvre completed position. The vehicle envelope may comprise a target defined manoeuvre completed position. The vehicle envelope may be determined in dependence on a one-dimensional property and/or measurement and/or estimation. The vehicle envelope may be determined in dependence on the environment signal being indicative of a length, such as an unobstructed length between features, the unobstructed length being sufficiently long for receiving the vehicle in the defined manoeuvre completed position. The vehicle envelope may be determined in dependence on a two-dimensional property and/or measurement and/or estimation. For example, the vehicle envelope may be determined in dependence on the environment signal being indicative of a length, such as between features, wherein along that length there is no obstruction within a particular width or breadth perpendicular to the length. The particular width or bready may correspond to at least a width or breadth of the vehicle, such as a vehicle width when the vehicle is parked and in a closed configuration, such as with vehicle aperture members closed. The particular width or breadth may correspond to at least a length of the vehicle, such as a vehicle length when the vehicle is parked and in the closed configuration in a perpendicular or parking lot or fishbone diagonal parked position. The vehicle envelope may comprise at least one dimension of a parking area and the defined manoeuvre completed position may be a parked position. The vehicle envelope may correspond to a predefined parking space. The vehicle envelope may comprise a target length, area or volume for receiving the vehicle in or on in the defined manoeuvre completed position.

The control means may be arranged to define at least two vehicle envelopes within the vacancy, each vehicle envelope comprising a discrete defined manoeuvre completed position that is offset within the vacancy.

The two vehicle envelopes may be non-overlapping. Alternatively, the two vehicle envelopes may be overlapping.

The two vehicle envelopes may extend in respective longitudinal directions adjacent and parallel each other. Alternatively, the two vehicle envelopes may extend along a same longitudinal axis, with a first vehicle envelope being longitudinally displaced along the longitudinal axis from a second vehicle envelope. In a yet further alternative, the vehicle envelops may be arranged with non-parallel longitudinal axes, such as with a first vehicle envelope having a longitudinal axis perpendicular to a longitudinal axis of a second vehicle envelope.

According to an aspect of the invention, there is provided a system, comprising: the controller as described above, arranged to receive the ambient condition signal and to output the manoeuvre signal; and actuator means for receiving the manoeuvre signal to cause the vehicle to perform the defined manoeuvre in dependence on the ambient condition in the vicinity of the vehicle.

The system may comprise ambient condition sensing means for determining the one or more ambient conditions in the vicinity of the vehicle and outputting the ambient condition signal indicative thereof.

The system may comprise environment sensing means for determining a location of one or more features in the vicinity of the vehicle and outputting an environment signal indicative thereof.

The system may comprise the controller arranged to control the output means to cause the vehicle to perform at least a portion of the defined manoeuvre in accordance with a vehicle movement control profile determined in dependence on the ambient condition signal.

The system may comprise a controller arranged to select the vehicle movement control profile in dependence on the one or more features.

The system may comprise a controller arranged to select the vehicle movement control profile in dependence on a location of the vehicle.

The system may comprise a controller arranged to select the vehicle movement control profile for performing the defined manoeuvre in dependence on a drive mode of the vehicle. The drive mode of the vehicle may comprise one or more of: “off-road”, “sport”, “normal”; “race; “comfort”; “individual”, “economy” etc. The drive mode may correspond to vehicle parameters, such as ride settings.

The system may comprise a controller arranged to select the vehicle movement control profile for performing the defined manoeuvre in dependence on a presence of an occupant in the vehicle.

The system may comprise: receiver means for receiving a signal indicative of a user request for vehicle movement and outputting a request signal in dependence thereon. The receiver means may be for wirelessly receiving the signal from a mobile device.

The system may comprise a controller arranged to receive a terrain signal indicative of at least one terrain in a vicinity of the vehicle. The controller may be arranged to select the vehicle movement control profile for performing the defined manoeuvre in dependence upon the terrain signal.

The system may comprise: terrain sensing means for determining a terrain in the vicinity of the vehicle and outputting the terrain signal indicative thereof.

According to an aspect of the invention, there is provided a method of controlling movement of a vehicle to perform a defined manoeuvre, the method comprising: receiving an ambient condition signal indicative of an ambient condition in a vicinity of the vehicle; and controlling an output means in dependence on the ambient condition signal such that at least a portion of the defined manoeuvre is performed in dependence on the ambient condition in the vicinity of the vehicle.

The method may comprise determining the ambient condition with an ambient condition sensing means.

The method may comprise controlling the output means in dependence on the ambient condition signal such that at least a portion of the defined manoeuvre is performed in accordance with a vehicle movement control profile dependent upon the ambient condition in the vicinity of the vehicle.

The method may comprise selecting the vehicle movement control profile in dependence on a drive mode of the vehicle.

The method may comprise selecting the vehicle movement control profile in dependence on a presence of an occupant in the vehicle.

The method may comprise determining a terrain in the vicinity of the vehicle and selecting the vehicle movement control profile in dependence upon the terrain.

The method may comprise determining a location of one or more features in a vicinity of the vehicle with an environment sensing means. The method may comprise selecting the vehicle movement control profile in dependence upon the one or more features.

The method may comprise receiving a signal from a mobile device indicative of a user request to perform the defined manoeuvre.

According to an aspect of the invention, there is provided a vehicle comprising a controller according to an aspect of the invention, a system according to an aspect of the invention or arranged to perform a method according to an aspect of the invention.

According to an aspect of the invention, there is provided computer software which, when executed by a processing means, is arranged to perform a method according to an aspect of the invention. The computer software may be stored on a computer readable medium. The computer software may be tangibly stored on a computer readable medium. The computer readable medium may be non-transitory.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers in a control system collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows a vehicle with an ambient condition in a vicinity of the vehicle;

FIG. 2 shows a controller according to an embodiment of the invention;

FIG. 3 shows a system according to an embodiment of the invention;

FIG. 4 shows a method according to an embodiment of the invention;

FIG. 5 illustrates a vehicle according to an embodiment of the invention; and

FIG. 6 is a vehicle according to an embodiment of the invention.

### DETAILED DESCRIPTION

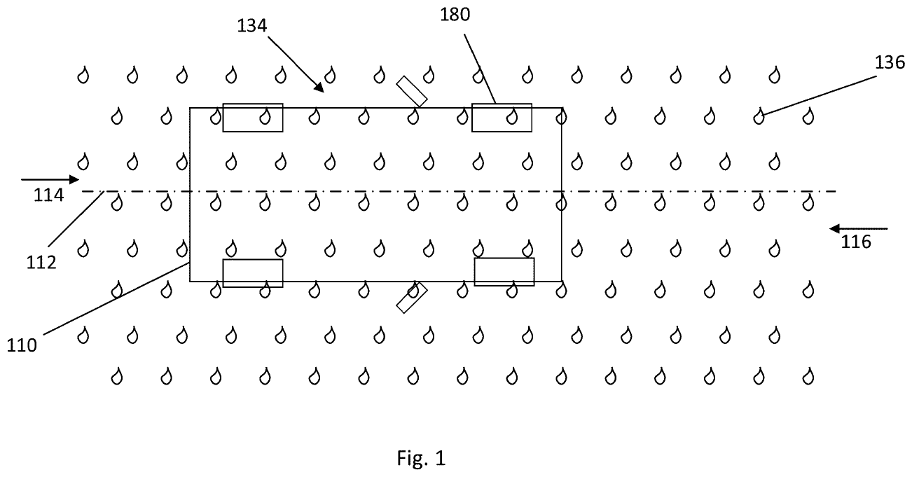

FIG. 1 illustrates a vehicle 110 according to an embodiment of the invention.

In FIG. 1 the vehicle 110 is shown at a defined manoeuvre start position in advance of performing a defined manoeuvre, such as to a parked positioned of the vehicle 110. The vehicle is shown here with a longitudinal axis 112 and having a vehicle forward direction, indicated by arrow 114. Here an ambient condition in the vicinity of the vehicle is shown as precipitation 136, such as rain. The ambient condition is not limited to being precipitation and may include, for example, a temperature; an air temperature; a surface temperature, such as a road temperature; precipitation, such as rain, snow, hail; moisture; humidity; fog; mist; particles, such as airborne particles; light level; wind; wind speed; wind direction.

It will be understood that the defined manoeuvre may be a manoeuvre of the vehicle 110 which is performed automatically by the vehicle 110 i.e. under control of one or more systems of the vehicle 110. The defined manoeuvre may be considered to be performed automatically by the vehicle 110, or at least semi autonomously. In FIG. 1 the defined manoeuvre may be a parking manoeuvre to control the vehicle 110 to drive into a parking structure or parking place. In at last some situations, it may be advantageous for the manoeuvre to be performed whilst a person in control of the vehicle 110 is external to the vehicle 110. For example, access to the vehicle 110 may be limited after performing the defined manoeuvre.

The ambient condition or conditions may be such as to have an actual and/or a perceived effect on the performance of the defined manoeuvre, such as to physically and/or psychologically influence a user's experience of performance of the defined manoeuvre.

Embodiments of the present invention aim to ameliorate one or both of these problems.

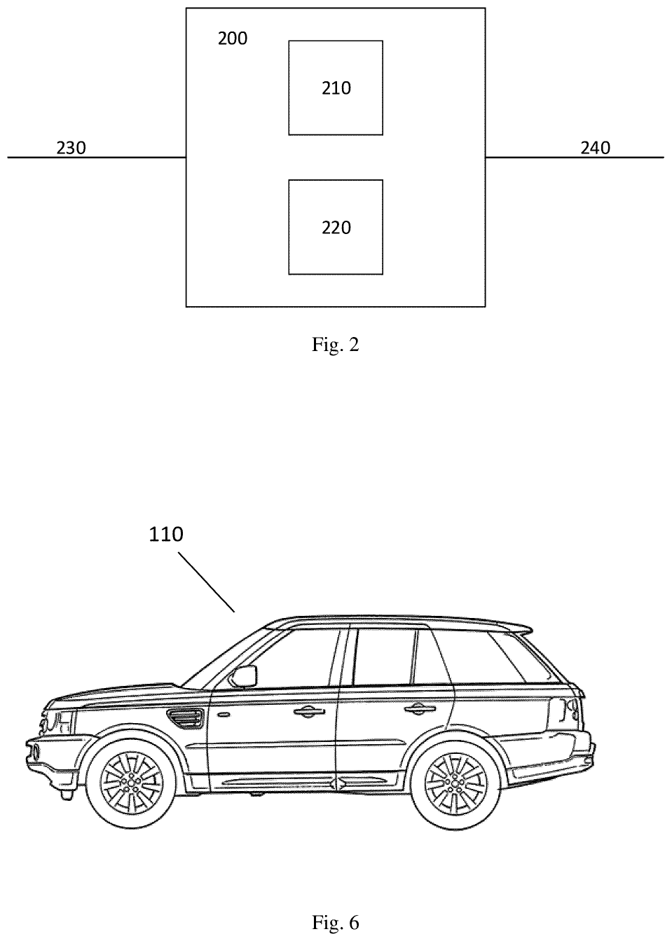

FIG. 2 illustrates a controller 200 or control unit 200 according to an embodiment of the invention, such as comprised in the vehicle 110 of FIG. 1.

The controller 200 comprises a control means 210, input means 230 and output means 240. In some embodiments the controller comprises a memory means 220 such as one or more memory devices 220 for storing data therein. The output means 240 may comprise an electrical output for outputting a manoeuvre signal. The manoeuvre signal represents an instruction for the vehicle 110 to move.

Here, the input means 230 is for receiving an ambient condition signal indicative of the ambient condition 136 in the vicinity of the vehicle 110. The control means 210 is arranged to control the output means 240 to cause the vehicle 110 to perform at least a portion of the defined manoeuvre in dependence on the ambient condition signal. Here, the control means 210 is arranged to control the output means 240 to cause the vehicle 110 to perform at least a portion of the defined manoeuvre in accordance with a vehicle movement control profile determined in dependence on the ambient condition signal. Accordingly, the vehicle 110 is caused to perform the defined manoeuvre in a controlled manner appropriate for the ambient condition.

The vehicle movement control profile comprises a speed parameter. Here, the speed parameter is indicative of a first order speed parameter. The control means 210 is arranged to select the vehicle movement control profile in dependence on a categorisation of the ambient condition 136. Advantageously, the control means 210 of the vehicle 110 automatically selects parameters for performance of the defined manoeuvre associated with predetermined categories of one or more ambient conditions. Here, the speed parameter is indicative of an acceleration and a jerk of the vehicle 110, jerk being a rate of change of acceleration of the vehicle 110. Accordingly, the vehicle 110 is caused to perform the defined manoeuvre with an appropriate acceleration, such as to perform the defined manoeuvre efficiently and/or without undue acceleration of the vehicle 110 or a user or content thereof. For example, as shown here with an ambient condition 136 of rain, the vehicle movement control profile is selected to provide reduced speed parameters, such as reduced maximum speed, maximum acceleration and maximum jerk. Accordingly, where there is an increased possibility of decreased grip (e.g. due to the rain wetting a road or other surface under the vehicle wheels 180); or at least an increased possibility of a user's perception of decreased grip, then the controller 200 adapts the performance of the defined manoeuvre to reduce the possibility of the vehicle 110 slipping or at least reduce a user's perception of the possibility of the vehicle 110 slipping. Accordingly, the vehicle 110 is caused to perform the defined manoeuvre with an appropriate speed, acceleration and rate of change of acceleration, which is physically and psychologically suited to the ambient conditions to be comfortable for the user.

It will be appreciated that for other ambient conditions, other vehicle movement control profiles may be used. For example, the maximum speed parameter of the vehicle movement control profile corresponding to the wet ambient condition 136 of FIG. 1 may be less than the maximum speed parameter of a vehicle movement control profile corresponding to a dry ambient condition. Accordingly, the maximum speed parameter can be varied to suit a variation in the ambient condition 136. It will be appreciated that the vehicle movement control profile can be varied during the performance of the defined manoeuvre: for example, if the ambient condition changes (e.g. if the rain only starts subsequent to initiation of the defined manoeuvre).

To perform the defined manoeuvre, the vehicle 110 comprises environment sensing means for determining a location of features in the vicinity of the vehicle 110. The environment sensing means may comprise one or more sensing devices or imaging devices. The one or more sensing devices may emit radiation and receive radiation reflected from the features in the vicinity of the vehicle, such as ultrasonic sensing devices, although it will be appreciated that the present invention is not limited in this respect. Such environment sensing means have a minimum distance to which accuracy the location of the features may be determined due to, for example, a resolution of an imaging device or a signal-to-noise ratio of a sensing device.

It will be appreciated, that in at least some examples, the environment sensing means provides the ambient condition signal, or at least an input therefor. For example, the environment sensing means may comprise a sensor or imaging device capable of detecting precipitation and/or mist and/or fog. Additional or alternative inputs from or for the ambient condition signal may include one or more of: one or more thermometers; one or more wipers; vehicle lighting; traction sensor. For example, where a wiper is activated, manually and/or automatically, then the control means 210 can be adapted accordingly, such as to a wet weather vehicle movement control profile, with a reduced speed parameter. Similarly, lighting of the vehicle 110, manually and/or automatically activated, is used in at least some examples to determine the light level ambient condition—and the control means 210 is arranged to adapt the output means 240 accordingly (e.g. to reduce the speed parameter in darker ambient conditions). The ambient condition signal may be at least partially dependent on an ambient condition measurement. In addition, or alternatively, the ambient condition signal may be dependent at least partially on an estimated condition. The estimated condition may be derived from one or more other parameters or statuses. For example, where a vehicle is in a geographic location (e.g. not in a tunnel, shadow, etc.) at a daytime for that location, then a low light level indication may be taken as indicative of an overcast or cloudy ambient condition.

Once in the defined manoeuvre completed position (not shown), the user typically applies a parking brake, to leave the vehicle stationary with the engine switched off.

The control means 210 may be formed by one or more electronic processing devices such as an electronic processor. The processor may operably execute computer readable instructions stored in the one or more memory devices 220. The control means 210 is arranged to control the output means 240 to output the manoeuvre signal in dependence on the environment signal, as will be explained. In some embodiments the input means 230 and output means 240 may be combined such as by being formed by an I/O unit or interface unit. For example, the controller 210 may comprise an interface to a network forming a communication bus of a vehicle. The interface bus may be an Internet Protocol (IP) based communication bus such as Ethernet, although embodiments of the invention are not limited in this respect.

Here, the input means 230 comprises an electrical input for receiving the ambient condition signal. The input means 230 may comprise an electrical input for receiving an environment signal. The input means 230 may comprise an electrical input for receiving a request signal. In at least some examples, the controller 210 comprises a second input means for receiving a request signal indicative of a received signal indicative of a user request, such as a wirelessly received signal.

It will be appreciated that the controller 200 may be arranged to perform a portion of the defined manoeuvre. For example, the user may initiate the manoeuvre with control being transferred to the controller 210 thereafter to complete the defined manoeuvre.

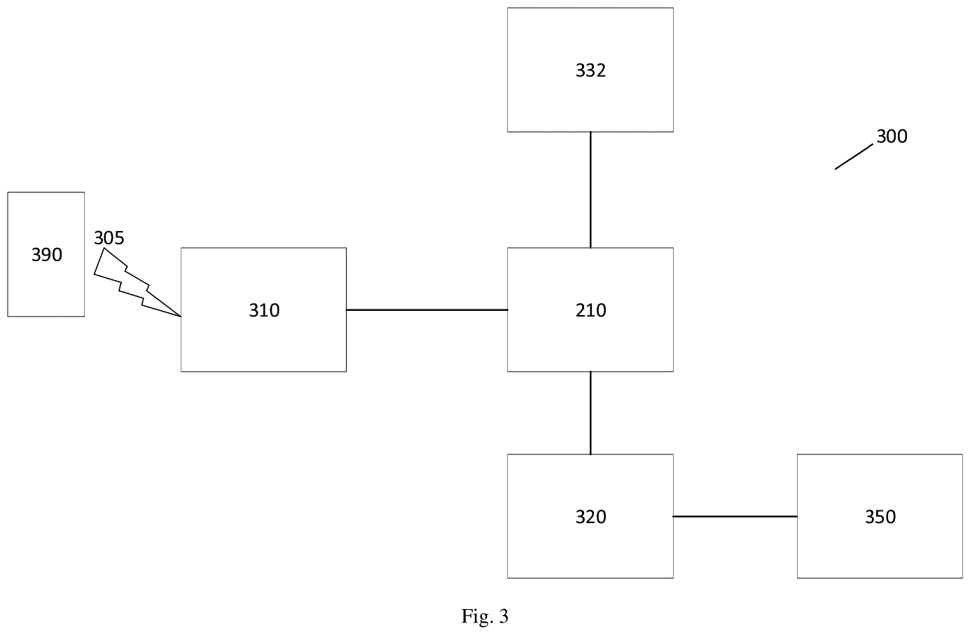

FIG. 3 illustrates a system 300 according to an embodiment of the invention. The system 300 comprises the controller 210 described above and shown in FIG. 2.

The system 300 comprises ambient condition sensing means 332 for determining information about an ambient condition in the vicinity of the vehicle 110. The ambient condition sensing means 332 is arranged to output an ambient condition signal indicative of the determined ambient condition. The ambient condition signal may be ambient condition data which may be stored in a memory. The ambient condition sensing means may comprise one or more sensing devices such as environment sensing means (e.g. imaging devices, such as cameras, or other sensing devices such as LIDAR, radar, ultrasonic devices, sonar devices etc.); thermometers; precipitation sensors; traction sensors; light sensors. Signals output by each of the sensing devices may be used to form a representation of the ambient conditions in the vicinity of the vehicle 110 which is stored in the memory for use by other systems of the vehicle 110. In at least some examples, the ambient condition signal is dependent at least partially on an estimated condition. The estimated condition may be based, for example, on a geographic location, a time of day, time of week, time of year, weather forecast; and/or another vehicle system in addition or instead of the ambient condition sensing means.

Here, the vehicle comprises environment sensing means for determining a location of at least one feature in the vicinity of the vehicle; and outputting an environment signal indicative thereof. The environment sensing means is arranged to determine a location of features such as surface markings, which may be painted lines denoting a perimeter of a parking bay, for example, or objects such as walls, posts or other vehicles in relation to which the vehicle is required to manoeuvre. The control means is arranged to determine an absence of features, such as a separation between obstructive features (not shown) in dependence on the environment signal. Accordingly, the control means is arranged to determine a vacancy where no features, such as no obstructive features, are located. Where the vacancy is sufficiently great, the control means is arranged to determine a vehicle envelope suitable for receiving the vehicle 110 in the defined manoeuvre completed position. The vehicle envelope comprises a target position suitable for receiving the vehicle 110 in the defined manoeuvre completed position. As such, the vehicle envelope comprises a target defined manoeuvre completed position. In at least some examples, the vehicle envelope is determined in dependence on a one-dimensional property and/or measurement and/or estimation. In particular, the vehicle envelope can be determined in dependence on the environment signal being indicative of a length, such as an unobstructed length between features (not shown). The unobstructed length is sufficiently long for receiving the vehicle 110 in the defined manoeuvre completed position, the length being a separation between features that is greater than the vehicle length or width in the defined manoeuvre completed position. The defined manoeuvre may comprise, for example, parking in a parked position.

The controller 210 of the system 300 here comprises defined manoeuvre means. The control means is arranged to control the vehicle 110 to perform at least one defined manoeuvre. The controller 210 may comprise a defined manoeuvre controller for controlling one or more systems of the vehicle 110 to perform one or more defined manoeuvres. The defined manoeuvre means may be associated with one or more actuators 350 of the vehicle 110. The one or more actuators 350 are provided for effecting movement of the vehicle 110. The actuators may comprise one or more of a power steering mechanism arranged to provide steering of wheels of the vehicle 110 in dependence on signals received from the controller 210. A second actuator may comprise a powered braking mechanism of the vehicle 110 which is arranged to actuate brakes of the vehicle in dependence on signals received from the controller 210. A third actuator comprises the powertrain of the vehicle. The controller 210 is arranged to control the steering of the vehicle wheel 180 relative to the feature.

The system 300 shown here comprises a motive control means 320. The motive control means 320 may be a motive control unit. The motive control means 320 is arranged to receive the manoeuvre signal output by the controller 210. The motive control means 320 is associated with one or more motive units of the vehicle 110 which may form part of a powertrain (not shown) of the vehicle 110. The motive units may comprise one or more of an internal combustion engine and one or more electric machines of the vehicle 110. The powertrain is arranged to provide power, or torque, to cause movement in the longitudinal axis of the vehicle 110 i.e. forward or backward movement of the vehicle 100 in dependence on the manoeuvre signal received from the controller 210. The motive control means 320 is arranged to control the application of torque to one or more wheels of the vehicle 110 to move the vehicle 110 in the longitudinal axis of the vehicle i.e. to move the vehicle generally forwards or backwards. The torque may comprise driving torque i.e. applied in a direction of desired movement, such as forwards. The torque may also comprise braking torque i.e. applied to resist the driving torque. In at least some embodiments both driving torque and braking torque may be applied simultaneously in order to provide low-speed movement of the vehicle 110. The braking torque may also be applied at least partly after the driving torque in order to effect accurate movement of the vehicle 110. To achieve control of the steering, the controller 210 may communicate with the motive control means 320. Thus the one or more actuators 350 can control a direction and movement of the vehicle to perform the defined manoeuvre. The defined manoeuvre is performed in dependence on the ambient condition signal provided by the ambient condition sensing means 332.

The one or more defined manoeuvres which may be performed by the vehicle 110 under control of the controller 210 may comprise a parking manoeuvre, such as a parking-in manoeuvre wherein the vehicle 110 is controlled to arrive at a parked position.

As shown here, the system 300 comprises a receiver means 310 for receiving a signal 305. The signal 305 may be wirelessly received from a mobile device 390 associated with a person responsible for the vehicle 110. The signal 305 is indicative of a user request for vehicle movement of the vehicle 110. The receiver means 310 is arranged to output the request signal to the input means 230 of the controller 210 as described above. The request signal may be output by the receiver means 310 onto a communication bus of the vehicle 110 which may communicably couple the components of the system 300.

The receiver means 310 may be in the form of a radio unit 310. The radio unit 310 may comprise a receiver for receiving radio signals 305 from the mobile device 390. In some embodiments the radio unit 310 may also comprise a transmitter, or may be a transceiver 310 configured to receive radio signals 305 transmitted from the mobile device 390 and transmit signals to the mobile device 390. The radio unit 103 and the mobile device 390 may be arranged to provide a wireless local area network, via which two-way communication may take place between the radio unit 103 and the mobile device 390. For example, the radio unit 103 may be arranged to communicate by WiFi (RTM) with the mobile device 390. In alternative embodiments other radio communication standards may be used for the communication. In one example, communication between the radio unit 103 and the mobile device 390 is provided via Bluetooth (RTM), although other protocols or standards may be envisaged.

The mobile device 390 may be an electronic key fob associated with the vehicle 110, such as may be used to gain entry and to activate or power up the vehicle 110. The mobile device 390 may, in other embodiments, be an electronic device associated with the person responsible for the vehicle 100 such as a mobile telephone, tablet, watch, wearable electronic device or other computing device associated with the person. The mobile device 390 is capable of receiving a user input indicating the person's desire to move the vehicle 110. The user input may be provided in the form of a button or key press, activation of a graphically displayed icon, a gesture or voice command. Other forms of user input may also be envisaged.

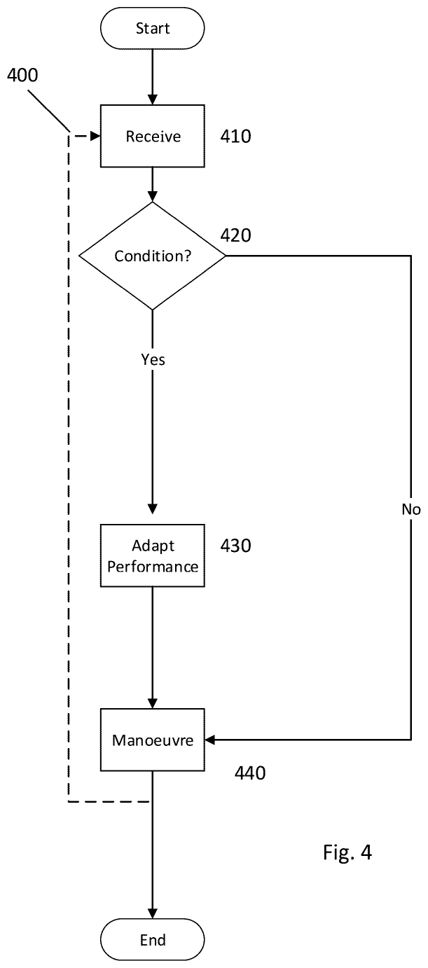

FIG. 4 illustrates a method 400 according to an embodiment of the invention. The method 400 is a method of controlling movement of the vehicle 110. The method 400 may be formed by the controller 210 and system 300 described above with reference to FIGS. 2 and 3. The method 400 will be described with reference to FIG. 4 as an example which corresponds broadly to the situation shown in FIG. 1.

The method 400 broadly comprises steps of receiving 410 the ambient condition signal from the ambient condition sensing means 332 which is indicative of an ambient condition in a vicinity of the vehicle 110 and, in dependence thereon, controlling 440 the vehicle's 110 performance of a defined manoeuvre.

Referring to FIG. 4, the illustrated embodiment of the method 400 comprises a step of receiving 410 the ambient condition signal from the ambient condition sensing means 332. The controller 210 determines 420 whether the ambient condition signal is indicative of an ambient condition associated with an adaptation 430 of the performance of the defined manoeuvre 440, such as according to a particular vehicle movement control profile corresponding to the sensed ambient condition.

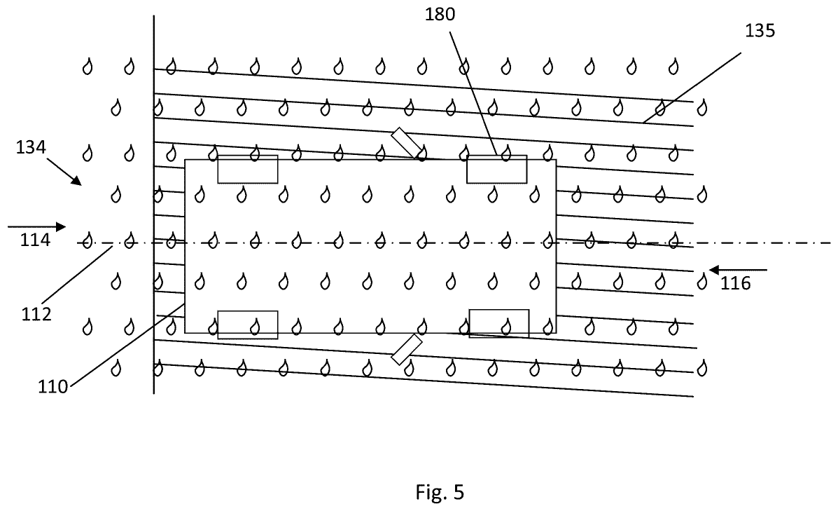

In FIG. 5, the vehicle 110 is illustrated as being located on a terrain 135 with a similar ambient condition 136 in the vicinity of the vehicle 110 as FIG. 1. The control means 210 is arranged to control the output means 240 to cause the vehicle 110 to perform at least a portion of the defined manoeuvre in accordance with a vehicle movement control profile determined in dependence on a terrain signal indicative of the terrain 135 and on the ambient condition signal indicative of the ambient condition 136. Accordingly, the vehicle 110 is caused to perform the defined manoeuvre in a controlled manner appropriate for the terrain 135 and the ambient condition 136. The control means 210 is arranged to select the vehicle movement control profile in dependence on a categorisation of the terrain 135 and of the ambient condition 136. Accordingly, the vehicle 110 automatically selects parameters for performance of the defined manoeuvre associated with predetermined categories of terrain 135 and ambient condition 136.

The terrain 135 is a surface. In at least some examples, the surface may comprise a ground surface, such as a load-bearing surface (e.g. vehicle-bearing). The surface may comprise a driveable surface, such as for receiving the vehicle wheels 180 thereon. The surface may comprise a substrate.

In at least some examples, the categories of terrain comprise one or more of: a road terrain; an off-road terrain; a bumpy terrain; a smooth terrain; a slippy terrain; a flat terrain; a material. Here, the terrain 135 is categorised according to one or more parameters corresponding to one or more of: bumpiness; smoothness; roughness; grip; slip; friction; one or more gradients; one or more inclines; one or more materials. The one or more parameters comprise a magnitude and/or a direction.

In some examples, in addition, or an alternative, to dependence on the terrain signal, the control means 210 is arranged to control the output means 240 in dependence on a topography signal indicative of a topography in the vicinity of the vehicle 110.

FIG. 6 shows a side view of an example vehicle according to an embodiment of the invention, being a car (private, passenger, non-service vehicle) as shown here.

As a result of the method 400 the vehicle may be more advantageously positioned or configured following performance of a defined manoeuvre. It will also be appreciated that embodiments of the present invention are not limited to being useful in association with a defined manoeuvre. For example, it may be useful to adapt or provide performance, such as of a portion of a defined manoeuvre, in dependence on an ambient condition even when being driven by a human driver.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine-readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A controller comprising:
input means for receiving an ambient condition signal indicative of an ambient condition in a vicinity of a vehicle;
output means for outputting a manoeuvre signal to cause the vehicle to perform a defined manoeuvre; and
control means arranged to control the output means to cause the vehicle to perform at least a portion of the defined manoeuvre in dependence on the ambient condition signal.

2. The controller of claim 1, wherein the control means is arranged to control the output means to cause the vehicle to perform at least a portion of the defined manoeuvre in accordance with a vehicle movement control profile determined in dependence on the ambient condition signal.

3. The controller of claim 2, wherein the vehicle movement control profile comprises a speed parameter.

4. The controller of claim 2, wherein the control means is arranged to select the vehicle movement control profile in dependence on a categorisation of the ambient condition.

5. The controller of claim 2, wherein the speed parameter is indicative of an acceleration of the vehicle, and/or wherein the speed parameter is indicative of a jerk of the vehicle, and/or wherein the speed parameter comprises a maximum speed parameter.

6. The controller of claim 5, wherein, when the speed parameter comprises a maximum speed parameter, the maximum speed parameter of a vehicle movement control profile corresponding to a first ambient condition is less than the maximum speed parameter of a vehicle movement control profile corresponding to a second ambient condition.

7. The controller of claim 2, wherein the movement control profile is dependent upon a terrain in a vicinity of the vehicle.

8. The controller of claim 1, wherein the controller comprises a second input means for receiving a request signal indicative of a received signal indicative of a user request.

9. The controller of a claim 1, wherein the defined manoeuvre is a parking manoeuvre.

10. A vehicle comprising the controller according to claim 1.

11. A method of controlling movement of a vehicle to perform a defined manoeuvre, the method comprising:
receiving an ambient condition signal indicative of an ambient condition in a vicinity of the vehicle; and
controlling an output means in dependence on the ambient condition signal such that at least a portion of the defined manoeuvre is performed in dependence on the ambient condition in the vicinity of the vehicle.

12. The method of claim 11, wherein the output means is controlled in dependence on the ambient condition signal such that at least a portion of the defined manoeuvre is performed in accordance with a vehicle movement control profile dependent on the ambient condition in the vicinity of the vehicle.

13. The method of claim 12, comprising selecting the vehicle movement control profile in dependence on a drive mode of the vehicle.

14. The method of claim 13, comprising selecting the vehicle movement control profile in dependence on a presence of a user in the vehicle.

15. A vehicle configured to perform the method according to claim 11.
